(19) United States
(12) Patent Application Publication
(10) Pub. No.: US 2026/0143367 A1
(43) Pub. Date: May 21, 2026

(54) METHODS, ARCHITECTURES, APPARATUSES AND SYSTEMS FOR DETECTING AND RESPONDING TO SENSING OUTAGES

(71) Applicant: InterDigital Patent Holdings, Inc., Wilmington, DE (US)

(72) Inventors: Muhammad Awais Jadoon, London (GB); Filipe Conceicao, London (GB); Alain Mourad, Ascot (GB)

(21) Appl. No.: 18/949,820

(22) Filed: Nov. 15, 2024

(51) Int. Cl. H04W 24/08; H04W 4/38

(52) U.S. Cl. CPC H04W 24/08; H04W 4/38

(57) ABSTRACT

Procedures, methods, architectures, apparatuses, systems, devices, and computer program products are provided for integrated sensing and communications. Wireless transmit/receive unit (WTRU) methods and systems include receiving, from a wireless network, sensing configuration information and outage information that indicates outage criteria and alternative sensing configurations associated with a plurality of metrics. The methods and systems further include performing sensing measurements based on the sensing configuration information, detecting sensing outages based on the outage criteria, and selecting, based on the one or more metrics corresponding to the sensing outage, an alternative sensing configuration to activate.

### TECHNICAL FIELD

The present disclosure is generally directed to the fields of communications, software and encoding, including, for example, to methods, architectures, apparatuses, systems related to integrated sensing and communication (ISAC) (e.g., detecting a target object based on configuration of at least one of a wireless transmit/receive unit or a wireless network).

### BACKGROUND

A device (e.g., a wireless transmit/receive unit) that is communicatively coupled to a wireless network may perform sensing-related measurements based on signals from the wireless network. During this process, sensing outages may occur.

### SUMMARY

A wireless transmit/receive unit (WTRU) can be configured for integrated sensing and communication. For example, a WTRU can perform sensing tasks based on receiving signals from and optionally reporting measurements to a wireless network. In some embodiments, a WTRU receives sensing configuration information from the wireless network and performs one or more sensing measurements based on the received sensing configuration. However, certain environmental conditions may cause decreased accuracy of the sensing operation, leading to the WTRU experiencing a sensing outage. For example, the WTRU may experience a sensing outage (e.g., corresponding to a moving car temporarily blocking a path of a signal being measured by the WTRU) when one or more metrics (e.g., associated with the sensing measurements) are above and/or below a desired level. In accordance with certain embodiments of this disclosure, the WTRU receives outage information that indicates outage criteria for a plurality of metrics as well as a plurality of alternative sensing configurations associated with the plurality of metrics. In one example, when the WTRU detects that an outage has occurred (e.g., that certain outage criteria has been met), the WTRU selects, based on the outage criteria met, an alternative sensing configuration (e.g., an alternative sensing measurement configuration and/or an alternative reporting configuration) from the plurality of alternative sensing configurations. Based on the systems and methods of this disclosure, sensing measurement tasks performed by the WTRU may be made more robust to changes in sensing environment conditions, while also conserving power and resources of the WTRU and/or wireless network.

In accordance with certain embodiments of the present disclosure, methods and systems arc provided for using a WTRU to perform sensing. In some embodiments, the methods include receiving, from a wireless network, sensing configuration information and outage information, where the outage information indicates outage criteria for a plurality of metrics and a plurality of alternative sensing configurations associated with the plurality of metrics. The methods also include performing one or more sensing measurements based on the sensing configuration information and detecting a sensing outage for at least one of the metrics based on the one or more sensing measurements and the outage criteria. The methods additionally include selecting, based on the at least one metric having the sensing outage, an alternative sensing configuration associated with the at least one metric from the plurality of alternative sensing configurations. The methods further include activating the alternative sensing configuration. In some embodiments, the methods additionally include determining a duration associated with the sensing outage based on the performed measurements as well as the received outage information.

In certain representative embodiments, the WTRU detects a sensing outage for an individual metric. For example, the WTRU detects a first sensing outage based on outage criteria being met for a first metric and a second sensing outage based on outage criteria being met for a second metric. In some embodiments, the WTRU detects a sensing outage based on multiple metrics (e.g., outage criteria for multiple metrics). In one example, the WTRU detects a total sensing outage based on detecting that a sensing outage is detected for a predetermined number of metrics (e.g., each metric of the plurality of metrics).

In certain representative embodiments, the alternative sensing configuration includes an alternative sensing measurement configuration and/or an alternative reporting configuration. For example, the WTRU may activate an alternative sensing measurement configuration (e.g., indicating decreased measurement periodicity) and perform one or more sensing measurements based on the alternative sensing measurement configuration (e.g., with decreased measurement periodicity). In some embodiments, the WTRU reports the alternative sensing measurement configuration to the wireless network and activates the alternative sensing measurement configuration based on receiving an acknowledgement from the wireless network. In some embodiments, the WTRU activates an alternative reporting configuration (e.g., indicating a reporting format excluding a particular measurement in outage) and reports the one or more performed measurements to the wireless network (e.g., excluding the particular measurement in outage).

In certain representative embodiments, the WTRU detects a past sensing outage and, for example, determines a duration of the past sensing outage. In some embodiments, the WTRU may select an alternative sensing configuration based on the past sensing outage. In some embodiments, the WTRU predicts a future sensing outage (e.g., and determines a predicted duration of the future sensing outage). The WTRU may predict the future sensing outage based on one or more previously detecting sensing outages. For example, the WTRU may select an alternative sensing configuration based on the predicted future sensing outage to conserve power and resources during the outage.

In certain representative embodiments, the WTRU predicts one or more metric values during the sensing outage and reports the one or more sensing measurements to the wireless network based on the predicted one or more metrics. For example, the WTRU may include in the sensing report an indication that the one or more sensing measurements is based on predicted metric values. In some embodiments, the WTRU predicts the one or more metric values by performing an interpolation based on one or more sensing measurements before the sensing outage.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example outage prediction function;

FIG. 3 shows an illustrative approach for predicting sensing metrics during an outage using interpolation; and

FIG. 4 shows a flowchart of an illustrative method performed by a WTRU for detecting and responding to sensing outages.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

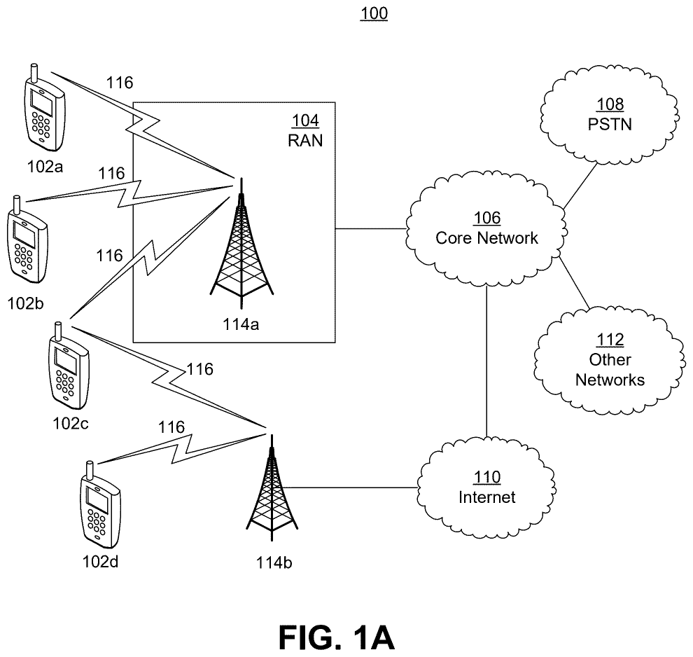

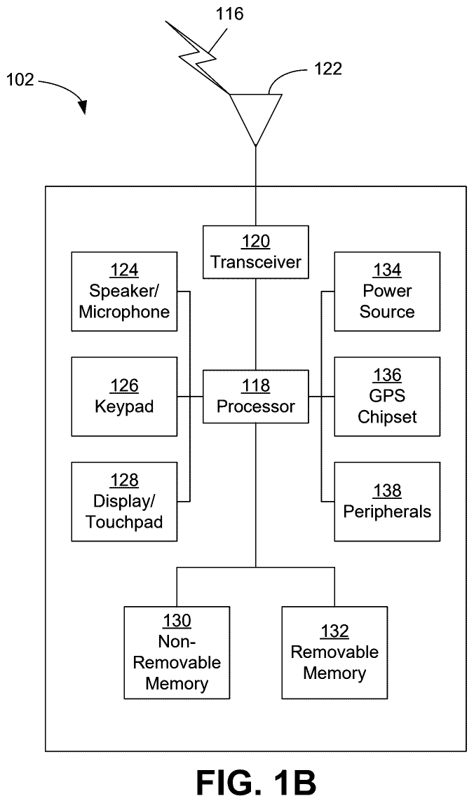

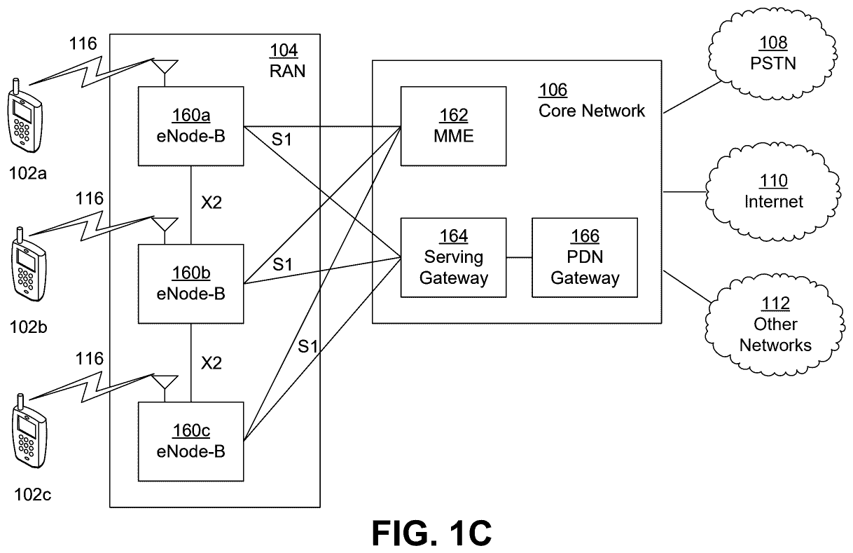

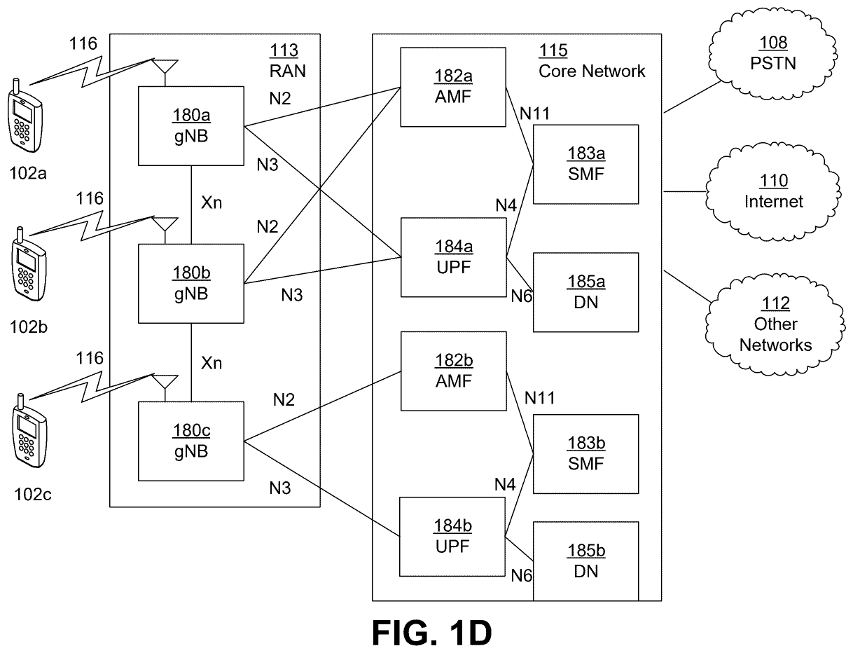

The methods, apparatuses and systems provided herein are well-suited for sensing and communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (NB), a Home Node-B (HNB), a Home cNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-Node-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as cNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, cNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

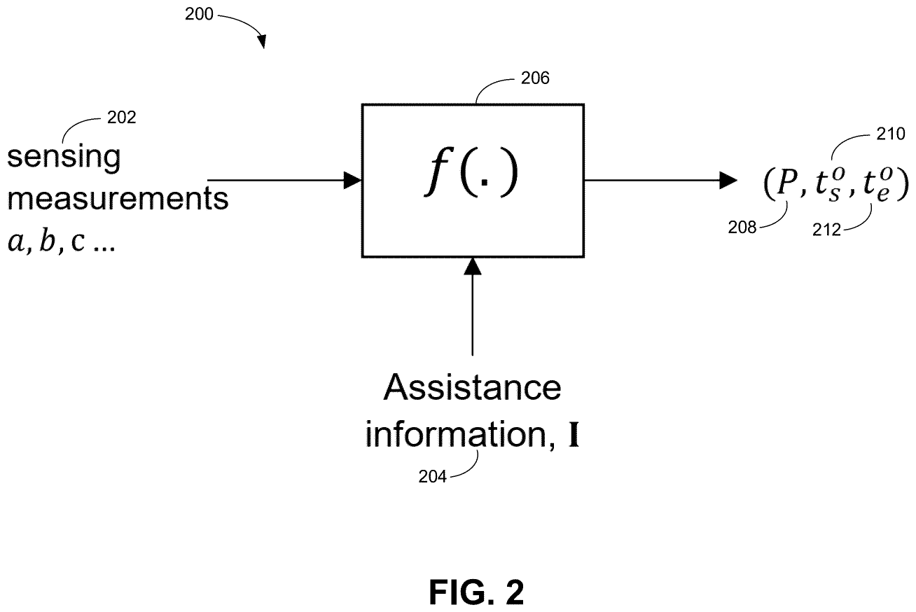

In certain embodiments of the present disclosure, including those described below at least in connection with FIGS. 2-4, the devices, systems, architectures, communication links, apparatuses, and other elements depicted in FIGS. 1A-1D may be used in connection with sensing configuration information and outage information indicating sensing outage detection and handling behavior.

During an ongoing sensing operation, sensing measurement performance may be determined by acquiring sensing metrics from radio signals. These sensing metrics may include delay, doppler, micro-doppler, angle (e.g., azimuth angle of arrival (A-AOA), zenith angle of arrival (Z-AOA)), radar cross-section (RCS), and/or material properties (e.g., reflectivity or permittivity) of the target. A sensing metric may be a function or two or more other sensing metrics, e.g., RCS may depend on delay, doppler, and reference signal received power (RSRP). For example, a WTRU may observe that the accuracy of one or more sensing metrics is not achieved within an allocated time budget provided by a wireless network. The decreased accuracy of the one or more sensing metrics may be linked to at least one of a broken line of sight (LOS) with a target, poor channel conditions, substantial interference (e.g., due to the mobility of the WTRU or the target), combinations of the same, or the like. Consequently, the WTRU may experience low signal-to-noise ratio (SNR), leading to the degradation of sensing performance.

The accuracy of a sensing metric may be defined in terms of confidence level, uncertainty, or any other method for measuring performance of the sensing metric. The accuracy may also be defined in terms of SNR or an expected range of values for the metric. Sensing metric accuracy may be defined on a per-metric basis, e.g., determined based on the network-defined threshold value (e.g., SNR threshold value) of each metric. In some examples, the sensing metric accuracy is determined based on the accuracy of an associated sensing result. For example, the WTRU determines that the desired accuracy of a sensing metric (e.g., delay measurement) is not achieved based on determining that the desired accuracy of an associated sensing result (e.g., range) is not achieved.

In some examples, while the accuracy of one or more sensing metrics is above a desired threshold accuracy, the accuracy of one or more other sensing metrics may be below the desired threshold accuracy of the measurements. In one example of an orthogonal frequency division multiplexing (OFDM)-based system, e.g., in 5G New Radio (NR), more bandwidths may be allocated to a particular reference signal for the sensing operation. The WTRU that receives the reference signal may take measurements (e.g., from one or more samples) to determine delay and doppler values. The WTRU may determine delay values to be above a configured threshold while determining doppler values to be below the configured threshold for doppler.

In certain representative embodiments, a WTRU may determine a situation in which values of one or more sensing metrics are below a threshold value (e.g., an expected value) and remains below the threshold value for a certain time duration (e.g., the sensing measurement time period) as an outage event for the one or more sensing metrics. The WTRU may determine a total outage based on determining that a subset of sensing metrics or all sensing metrics (e.g., that are essential to a particular sensing operation) fall below a threshold value (e.g., a SNR and/or RSRP threshold) for a certain time duration. In some embodiments, outage of one or more sensing metrics or a total outage may also be determined by at least one of signal-to-interference-plus-noise ratio (SINR), reference signal received power (RSRP), Cramer-Rao lower bound (CRLB), or any other suitable parameter, or any combination thereof.

In current systems and standards, detection and handling of sensing outage events is not addressed or well-defined. In the event of an outage, accuracy of sensing measurements may not be met, and therefore, power and resources may be wasted if the WTRU continues to take measurements of one or more sensing metrics (e.g., delay, doppler, angles, RCS). The unnecessary overconsumption of power may be exacerbated in sensing applications requiring a high refresh rate and bandwidth, e.g., high accuracy localization and tracking.

Moreover, the outage of one or more sensing metrics may occur while the outage of one or more other sensing metrics may not occur. Therefore, methods for preserving power and resources in the event of an outage are needed. In one example, doppler resolution may be needed for a sensing operation, and more OFDM resource elements (REs) are allocated to the sensing operation. If the doppler resolution cannot be met during an outage, the magnitude of wasted resources may be high. Thus, during the outage period, power saving and resource saving strategies may be considered, e.g., that reduce the number of time domain symbols allocated to the sensing operation. As another example, if range resolution cannot be met during an outage, power can be conserved by reducing the sub-bands allocated to sensing signal. Proactive detection of an outage event may enable the conservation of power and resources (e.g., time, frequency, and space resources).

Accordingly, systems and methods are described as follows that enable a WTRU (e.g., WTRU 102 of FIGS. 1A-D) to proactively detect and/or assist a wireless network (e.g., RAN 104 and 113 of FIGS. 1A-D) with detecting an outage as a function of sensing metrics, as well as perform outage handling to conserve power and resources.

In some embodiments, the WTRU receives sensing configuration information and outage information that indicates outage criteria for a plurality of sensing metrics. For example, the WTRU may receive outage criteria comprising a threshold, range of values, and/or confidence level for each sensing metric of the plurality of sensing metrics. In one example, the WTRU may be configured to determine a total outage if the range and doppler values both are outside of their respective received ranges and fall below a SNR threshold. In another example, the WTRU may receive positioning reference signals (PRSs) and be configured to send a sensing report after every 5 PRS transmissions, e.g., PRS signal is transmitted every 50 milliseconds (ms) and the WTRU sends a sensing report every 250 ms. In another example, the WTRU may be configured to take measurements from sensing signals to determine sensing metrics, e.g., measuring PRS signals transmitted periodically with comb size 2. The WTRU may keep past measurements of sensing signals, e.g., measurements of 5 PRS signals transmitted at time t-4, t-3, t-2, t-1, and t.

In certain representative embodiments, the sensing configuration information includes sensing measurement configuration information (e.g., sensing measurement periodicity, bandwidth, time window, combinations of the same, or the like). The sensing configuration information may also include reporting configuration information. In some embodiments, the reporting configuration information includes at least one of the following: a reporting periodicity; a reporting mechanism (e.g., via RRC, via MAC-CE, or the like); a reporting format (e.g., indicating reported measurements); combinations of the same; or the like.

In certain representative embodiments, the outage information includes alternative sensing configurations that are activated by the WTRU based on detecting a sensing outage. The alternative sensing configurations may comprise alternative reporting configurations for different outage scenarios. In one example, the WTRU is configured to exclude measurements for range and doppler from the sensing report when range and doppler are determined to be in outage. In another example, the WTRU is configured to exclude micro-doppler measurements from the sensing report but not the doppler measurements when both micro-doppler and doppler measurements are determined to be in outage. The alternative sensing configurations may comprise different alternative sensing measurement configurations for different outage scenarios. For example, the WTRU may activate an alternative sensing measurement configuration upon detecting a doppler outage, e.g., a sensing measurement configuration with less resources allocated to sensing measurements associated with doppler measurements.

In certain representative embodiments, the outage information may additionally or alternatively indicate total outage criteria. For example, the WTRU may be configured to determine a total outage if two or more sensing metrics are below a certain threshold.

In some embodiments, the WTRU performs one or more measurements of sensing signals (e.g., PRSs) based on the received sensing configuration information, and the WTRU may determine sensing metrics based on the performed one or more measurements.

In some embodiments, the WTRU detects an outage, e.g., based on the one or more measurements of sensing signals and/or the outage criteria. For example, the WTRU may detect a total outage event based on determining that the total outage criteria are met. In some embodiments, the WTRU may additionally determine an outage duration associated with the outage, e.g., for one or more sensing metrics. The outage duration may be determined based on a past outage and the measurements taken by the WTRU during the past outage. The outage duration may also be determined for a future outage based on measurements taken by the WTRU during a past outage and/or one or more prediction techniques. In one example, the WTRU detects an outage and determines an outage duration at a time t, e.g., corresponding to range, time difference of arrival (TDoA), and AoA values determined to be outside a configured range for PRS #2 and PRS #1 transmitted at times t−1 and t, respectively. The WTRU may determine that the outage (e.g., of range, TDoA, and AoA) and/or a future outage may last for 2 more PRS signal transmissions, e.g., for PRS signals at times t+1 and t+2.

In certain representative embodiments, the WTRU reports the outage to the wireless network. The WTRU may report one or more of the following: the values of sensing metric measurements; the mean and/or standard deviation of each sensing metric measurements, e.g., for the past five PRS signals; measurements performed during a past outage; duration of a past outage; prediction of a duration of a future outage; or predicted values of one or more sensing metrics during a past or future outage. The WTRU may not include particular sensing measurements (e.g., AoA and range for PRS #2 and PRS #3) in the sensing report based on an active reporting configuration of the WTRU.

In certain representative embodiments, the WTRU performs actions based on the detection of the outage, e.g., before and/or after reporting the outage to the wireless network. In one example, the WTRU, autonomously or after receiving an indication from the wireless network, activates an alternative sensing configuration based on characteristics of the outage. The alternative sensing configurations may be associated with one or more sensing metrics and/or outage criteria, e.g., through a lookup table of configurations provided by the wireless network to the WTRU as part of the outage information. In another example, the WTRU, autonomously or after receiving an indication from the wireless network, activates an alternative reporting configuration based on characteristics of the outage. The alternative reporting configurations may be associated with one or more sensing metrics and/or outage criteria, e.g., through a lookup table of configurations provided by the wireless network to the WTRU as part of the outage information.

The systems and methods described herein may help save resources of the wireless network, save power of the WTRU, and reduce signaling overhead. Moreover, they may result in reduced latency in producing sensing results for a sensing operation.

In accordance with certain embodiments of the present disclosure, systems and methods for detecting and reporting outages are described as follows.

In some embodiments, the WTRU receives sensing configuration information and outage information, e.g., including outage criteria. For example, the WTRU may be configured to sense multiple target objects and receive sensing configuration information and outage information for each target object (e.g., associated with a different set of sensing requirements).

In some embodiments, the WTRU receives per-metric outage criteria, e.g., including a threshold and/or confidence level, to identify outages, e.g., in accordance with the requirements of the sensing operation. The outage criteria may include one or more of: a threshold value for each metric and corresponding confidence levels; or an SNR, RSRP, and/or SINR threshold for each metric. For example, an outage may be determined if one metric (e.g., delay) is below a threshold value. Each sensing metric may have different threshold requirements to determine accuracy of overall sensing operation. The sensing metrics may differ across sensing operations.

In some embodiments, the WTRU may also receive a time trigger (e.g., associated with a duration) for use in outage detection. In one example, the wireless network configures the WTRU to determine an outage based on the values of sensing measurements of one or more metric being below a threshold for the duration associated with the time trigger.

In some embodiments, the WTRU receives total outage criteria, e.g., that cause the WTRU to determine a total outage if two or more parameters are below a certain threshold. In one example, the WTRU may receive total outage criteria that cause the WTRU to detect a total outage if both delay and doppler are below certain thresholds. In this example, the WTRU does not detect a total outage if either delay or doppler are above their respective thresholds. Unlike the per-metric outage criteria, total outage criteria may include a combination of one of more metrics or all the metrics determined to be relevant to a particular sensing operation or a sensing task.

In some embodiments, the WTRU receives outage information indicating alternative sensing configurations to be activated when an outage is detected. The alternative sensing configurations may be activated based on determining that a corresponding one or more sensing metrics are in outage.

In some embodiments, the WTRU performs one or more measurements on sensing signals to determine sensing metrics. These sensing signals may include 5G NR reference signals (e.g., CSI-RS, PRS) or any other reference signals designed for sensing. In one example, the WTRU performs measurements for each sensing metric as defined by the wireless network for each sensing operation. The WTRU may determine to perform only a subset of measurements, e.g., measurements required for the sensing operation, based on receiving a request from the wireless network. For example, one sensing operation requires micro-doppler measurements while a different sensing operation does not require micro-doppler measurements. In this example, the WTRU does determine not to perform micro-doppler measurements in the different sensing operation. In another example, a sensing operation requires orientation measurements but does not require velocity measurements.

In accordance with certain embodiments of the present disclosure, systems and methods for detecting an outage and determining a corresponding outage duration are described as follows.

In some embodiments, the WTRU detects a past outage and determines the corresponding outage duration based on the past outage. In one example, the WTRU stores performed measurements in a buffer and/or memory. The stored measurements may be maintained for a certain amount of time. The WTRU may determine a certain duration in the past measurements corresponding to the outage (e.g., a number of measurements with values below a certain threshold). The WTRU may determine the outage for a subset of sensing metrics or all sensing metrics. In another example, the outage duration includes a time window in the past, e.g., linked to one or more reference signals transmitted by the wireless network during the sensing operation. The WTRU may, for example, determine that values acquired for PRS signals transmitted at time t−1 and t−2 arc in outage.

In one example, the detection of the outage is based on measurements of channel parameters such as TDoA, time drift (TD), or any other standard measurements. In another example, the detection of the outage is based on further processing of channel parameters to provide sensing data (e.g., delay, doppler, angle) obtained from reflection or diffraction of sensing signals. In another example, the WTRU detects an outage linked to doppler with a confidence P based on the doppler measurements being less than a certain (e.g., configured) threshold for a certain amount of time.

In some embodiments, the WTRU determines a future outage and predicts the corresponding outage duration, e.g., based on past measurements. In one example, the WTRU considers the measurements and time windows of past detected outages to predict future outages and their corresponding durations. This may be particularly useful in ISAC due to potential temporal or spatial dependencies of sensing measurements. Furthermore, artificial intelligence (AI) and machine learning (ML) models may be used to predict outage duration with a certain confidence. For example, the WTRU may use ML models provided by the wireless network or WTRU vendor-specific ML models to predict the future outage and/or the outage duration, e.g., based on past measurements. The predicted outage duration corresponding to a future outage may be upper bounded by the total time budget in which a sensing operation is to be performed.

In some embodiments, different types of outages exist and the WTRU is configured with different criteria for each outage type. One example of a type of outage is a single-parameter outage, e.g., corresponding to the outage of a single metric and/or set of measurements. Another example of a type of outage is a multi-parameter outage, e.g., corresponding to the outage of more than one set of measurements. In one example, the WTRU detects a total outage when one or more sensing metrics fall below their respective thresholds and/or a subset of sensing metrics fall below their respective thresholds (e.g., SNR and RSRP thresholds). Total outage may be determined for both past outages and predicted future outages. Outage duration determination (e.g., for past outages and predicted future outages) may consider a subset of sensing metrics or all sensing metrics.

In some embodiments, the outage duration is determined using existing or new standard measurements such as TDoA, TD, or phase measurements. The outage duration may also be determined from values that are obtained as a function of these measurements and other past measurements. In one example, the outage duration is determined based on the channel impulse response and a particular time window of historical channel impulse response values. In another example, the outage duration is determined using only the SNR or RSRP, due to variable SNR, RSRP, and/or RSPP requirements for each sensing metric.

In some embodiments, the WTRU determines an outage duration (e.g., for past outages and predicted future outages) for each sensing target. The outage duration may be based on the conditions of the environment around the target object. In one example, multiple cars or unmanned aerial vehicles (UAVs) are being detected and/or tracked and outage for one or more target objects may be observed, while outage of one or more other target objects may not be observed. If one target object (e.g., a car) moves to a location where there is greater inference or that breaks the LoS, the other target object (e.g., a different car or UAV) may not observe the same conditions, and the WTRU may determine different outage durations for the different target objects.

In some embodiments, the WTRU reports to the wireless network about the outage. The report may be sent to the wireless network based on the outage information received from the wireless network. In some examples, the WTRU sends a report (e.g., indicating an outage) periodically or aperiodically to the wireless network. In other examples, the wireless network requests a report on-demand from the WTRU and the WTRU responds with a report (e.g., indicating an outage).

In accordance with certain embodiments of the present disclosure, examples of a WTRU detecting an outage are described as follows.

In one example, the WTRU receives a total time budget (e.g., T_{sensing}) during which a sensing task is to be performed, and measurements are to be taken by the WTRU. In this example, tₛ corresponds to the start time of the sensing task and tₑ corresponds to the end time of the sensing task. Similarly,

$${t}_{s}^{o} and {t}_{e}^{o}$$

may correspond to the part time and end time of outage, respectively.

The outage window (e.g., T_{outage}) therefore may be defined by formula (1) as follows:

$${T}_{outage} = {t}_{e}^{o} - {t}_{s}^{o} \qquad ( 1 )$$

The outage window may be determined by the WTRU for one or more sensing metrics x (e.g., delay, angles, doppler, micro-doppler, RCS) and may be defined by formula (2) as follows:

$${T}_{outage , x} = {t}_{e , x}^{o} - {t}_{s , x}^{o} \qquad ( 2 )$$

In some embodiments, the WTRU may only determine outages based on accuracy and/or quality of one or more sensing measurements within the total time budget T_{sensing}, such that the start of outage and the end of outage times fall within T_{sensing}, e.g.,

$${t}_{s}^{o} > {t}_{s} and {t}_{e}^{o} \leq {t}_{e} .$$

In some examples, the WTRU uses temporal measurements at layer one (L1) to detect an outage along with calculation of whether SNR, accuracy, and/or quality of one or more sensing metric is below a certain threshold since each data point (e.g., delay, doppler, micro-doppler, RCS, range) may be associated with different SNR or CRLB requirements.

In another example, the WTRU detects an outage based on assistance information I, e.g., related to the targets and/or sensing operation. The assistance information may include one or more of the following: the location of the receiver, transmitter, and/or targets; past measurements related to the targets; mobility (e.g., speed) patterns of the WTRU and/or targets; or a function or method for determining an outage of one or more sensing metrics. For example, the WTRU may detect an outage based on assistance information that includes different outage determination functions for different velocity ranges of the target and the WTRU. The WTRU may determine an overall accuracy of the sensing task based on a function of the accuracies of individual sensing metrics and the assistance information I, e.g., received by the WTRU from the wireless network.

FIG. 2 is a block diagram 200 illustrating an example outage prediction function. As shown in FIG. 2, in some embodiments, the WTRU (e.g., WTRU 102 of FIGS. 1A-D) provides one or more sensing measurements 202 (e.g., a, b, and c corresponding to delay, doppler, and angle) as an input to a prediction function ƒ(·) 206 at a time t. In one example, the WTRU additionally provides assistance information I 204 as an input to the prediction function 206. The prediction function 205 may determine a probability P 208 (e.g., a probability or confidence linked to the outage detection and/or duration), a predicted start time of outage

$${t}_{s}^{o}$$

210, and/or a predicted end time of outage

$${t}_{e}^{o}$$

212. In one example, one prediction function 206 additionally takes time t as an input to determine the probability and outage window outputs, in accordance with formula (3) defined as follows:

$$( P , {t}_{s}^{o} , {t}_{e}^{o} ) = f ( a , b , c , I , t ) \qquad ( 3 )$$

The predicted outage window may be bounded by Tₘₐₓ (e.g., a time until which the prediction is to be performed), in accordance with formula (4) defined as follows:

$$t \leq {t}_{s}^{o} \leq {t}_{e}^{o} \leq t + {T}_{max} \leq {t}_{e} \qquad ( 4 )$$

In accordance with certain embodiments of the present disclosure, systems and methods for activating an alternative sensing configuration (e.g., selected based on detected outage criteria) are described as follows.

In some embodiments, the WTRU activates an alternative sensing configuration that includes an alternative reporting configuration. In one example, the WTRU receives outage information (e.g., during an initial configuration and/or after detecting the outage) indicating alternative reporting configurations. Each alternative reporting configuration may correspond to one or more outage criteria, e.g., which trigger the activation of the alternative reporting configuration if met for longer than a minimum outage duration T_{Outage, min} (e.g., 100 ms or 1 second). In one example, a delay outage is detected based on determining that the measurement values of delay are below the delay threshold for T_{Outage, min}. Thus, the outage duration T_{Outage} is lower bounded by the minimum outage duration T_{Outage, min}. In one example, WTRU only activates an alternative reporting configuration based on determining that all outage criteria associated with the alternative reporting configuration are met, e.g., for longer than T_{Outage, min}.

Table 1 provides an example lookup table that may be used by a WTRU to map outage criteria to alternative reporting configurations accompanied by descriptions of the alternative reporting configurations. As shown in Table 1, the WTRU compares sensing metrics a, b, and c (e.g. corresponding to delay, doppler, and RCS) to their respective thresholds thₐ, th_{b}, and th_{c} to identify whether an outage criterion has been met, and then selects a corresponding alternative reporting configuration. In one example, the WTRU selects an alternative reporting configuration based on the lookup table and the outage criteria, and subsequently activates the alternative reporting configuration. In some embodiments, the WTRU may wait (e.g., via sending an acknowledgement) for the wireless network to confirm whether the WTRU may switch to the alternative reporting configuration before activating the alternative reporting configuration.

TABLE 1

| | Alternative | Reporting |
|---|---|---|
| Outage criterion met | reporting | configuration |
| (e.g., for T_{Outage, min}) | configuration | description |
| a < thₐ | A | Measurements of metrics in |
| b < th_{b} | A | outage are not reported |
| c < th_{c} | B | Measurement reporting |
| | | periodicity is decreased |
| a < thₐ and b < th_{b} | C | No measurements are reported |
| a < thₐ, | D | No measurements are reported |
| b < th_{b}, and c < th_{c} | | for x time slots (e.g., two |
| (e.g., total outage) | | reporting instances) |

In some embodiments, activating the alternative reporting configuration may include switching to an alternative reporting mechanism, e.g., radio resource control (RRC), medium access control control element (MAC-CE). In one example, the wireless network indicates the alternative reporting mechanism to the WTRU and the WTRU then switches to the alternative reporting mechanism. In another example, the WTRU detects that range and velocity are in outage and selects a reporting alternative reporting configuration to activate in which the reporting periodicity is decreased (e.g., from 100 ms to 1 second). In this example, the WTRU sends a special report to the wireless network to inform the wireless network about the change in reporting mechanism. In another example, the WTRU activating the alternative reporting configuration may include instantaneously switching reporting to a periodic mode (e.g., with aggregated measurements).

While the WTRU may report measurements that are below a threshold, this may waste resources and power as well as introduce signaling overhead. In some embodiments, the WTRU activating alternative reporting configuration includes determining not to report measurements to the wireless network and sending an indication of this change of reporting behavior to the wireless network. In one example, a WTRU configured to report measurements every 100 ms detects an outage lasting for 250 ms. The WTRU may choose to activate an alternative reporting configuration resulting in the WTRU not reporting the values of the measurements in the following two reports and resuming reporting after the outage duration. The WTRU may select which alternative reporting configuration to activate based on the duration of the outage.

In some embodiments, activating the alternative reporting configuration includes applying an alternative reporting format, e.g., following detection of an outage. For example, the WTRU excludes from the sensing reports sensing measurements taken during an outage to optimize usage of power and resources (e.g., decreasing the volume of sensing measurements to reduce the required bandwidth for reporting). Instead, the WTRU may report to the wireless network indications of which sensing measurements are in outage (e.g., including possible causes of outage) and are thus not included in the sensing report. In one example, the WTRU reports a bitmap, where each bit represents whether a sensing measurement is included in the report. In another example, the WTRU detects a total outage and activates an alternative reporting configuration that includes applying a sensing report format that only indicates the cause of the outage (e.g., without including any sensing measurements).

In some embodiments, the WTRU selects and activates an alternative sensing configuration that includes an alternative reporting format, which configures the WTRU to stop taking sensing measurements during the outage of one or more sensing metrics. The WTRU may not indicate to the wireless network that measurements were not taken during the outage. In one example, the WTRU adds dummy values (e.g., zeros) for the measurements during the outage duration, e.g., to indicate to the network the outage and/or the outage duration.

In other embodiments, the alternative reporting format configures the WTRU to send a periodic report of aggregated measurements from multiple sensing signals, e.g., excluding the sensing measurements that are associated with the outage. In such embodiments, the wireless network may re-configure the WTRU and the WTRU may perform sensing with re-configured resources to acquire the excluded values. Alternatively, the wireless network may decide to select a different WTRU (e.g., that is not in outage during the outage of the original WTRU) to provide the excluded values.

In some embodiments, the WTRU selects and activates an alternative reporting configuration, including an alternative reporting format, without a defined, configured, and/or detected outage. In one example, the WTRU observes no change in the environment and instead of sending all measurements, only provides an indication, e.g., of the constant values. This is important in certain use cases such as environment reconstruction and when there are no significant changes in the environment. In another example, the WTRU determines that a target vehicle and/or UAV is stopped at traffic light or in traffic congestion and has not moved. The WTRU may send a compressed report and/or a simple indication to inform the network regarding the vehicle and/or UAV instead of sending all the measurements taken to track the vehicle. In another example solution, the WTRU compares the new measurements to previous measurements and decides to skip and/or compress the new measurements, e.g., and reports the new skipped and/or compressed new measurements to the wireless network.

In some embodiments, the WTRU activates an alternative sensing configuration that includes an alternative sensing measurement configuration. In one example, the WTRU receives outage information (e.g., during an initial configuration and/or after detecting the outage) indicating alternative sensing measurement configurations. Each alternative sensing measurement configuration may correspond to one or more outage criteria, e.g., which trigger the activation of the alternative sensing configuration if met, for example, for longer than a minimum outage duration T_{Outage, min} (e.g., 100 ms or 1 second). In one example, WTRU only activates an alternative sensing measurement configuration based on determining that all outage criteria associated with the alternative sensing measurement configuration are met, e.g., for longer than T_{Outage, min}.

Table 2 provides an example lookup table used by a WTRU to map outage criteria to alternative sensing measurement configurations accompanied by descriptions of the alternative sensing measurement configurations. As shown in Table 2, the WTRU compares sensing metrics a, b, and c (e.g. corresponding to delay, doppler, and RCS), to their respective thresholds thₐ, th_{b}, and th_{c} to identify whether an outage criterion has been met, and then selects a corresponding alternative sensing measurement configuration. In one example, the WTRU selects an alternative sensing measurement configuration based on the lookup table (e.g., Table 2) and the outage criteria, and subsequently activates the alternative sensing measurement configuration. The WTRU may wait for the wireless network to confirm (e.g., via sending an acknowledgement) whether the WTRU may switch to the alternative sensing measurement configuration before activating the alternative sensing measurement configuration.

TABLE 2

| | Alternative sensing | |
|---|---|---|
| Outage criteria met | measurement | Sensing measurement configuration |
| (e.g., for T_{Outage, min}) | configuration | description |
| a < thₐ | A | Bandwidth of sensing signals for |
| | | measurements are reduced |
| b < th_{b} | B | Symbols, slots, subframes, and/or time |
| | | window of measurements are reduced |
| c < th_{c} | C | Measurement periodicity is decreased and/or |
| | | measurement gap is increased |
| a < thₐ and b < th_{b} | D | No measurements are taken for x time slots |
| | | (e.g., two reporting instances) |
| a < thₐ, | E | Bandwidth of sensing signals for |
| b < th_{b}, and c < th_{c} | | measurements are reduced; and symbols, |
| (e.g., total outage) | | slots, subframes, and/or time window of |
| | | measurements are reduced |

The alternative sensing measurement configurations may be provided by the wireless network to the WTRU via any message exchange (e.g., RRC). In one example, the WTRU detects the outage of range resolution and indicates the outage to the wireless network. The WTRU may select (e.g., and receive from the wireless network) an alternative sensing measurement configuration A that configures the WTRU to reduce bandwidth to x number of subcarriers to be used for measurement instead of a whole bandwidth or bandwidth part (BWP). The WTRU may activate sensing measurement configuration A for y amount of time before switching to a different sensing measurement configuration. Alternative sensing measurement configurations may reduce the signaling between the WTRU and the wireless network, saving WTRU resources and power.

In some embodiments, alternative sensing measurement configurations are implemented when the wireless network is limited in capacity, and the upper bound of the resource allocation is already provided to the WTRU in an initial resource allocation configuration (e.g., measuring PRS with comb size 6), e.g., in both the time and frequency domain). The resource allocation may be reduced by an alternative sensing measurement configuration for power saving purposes, given that the upper bound may exceed what is sufficient (e.g., necessary) for an accurate sensing measurement process.

In accordance with certain embodiments of the present disclosure, example alternative sensing measurement configurations are described as follows.

In some embodiments, the alternative sensing measurement configuration configures the WTRU to reduce bandwidth of measurement or implement selective sensing of carriers. In one example, the WTRU detects a range outage and selects an alternative sensing measurement configuration that reduces the bandwidth of measured signals to save power. In this example, the measurements taken with the alternative sensing measurement configuration may not achieve the desired accuracy. However, measurements taken of signals with reduced bandwidth (e.g., sub-band signals) may provide a good assessment of sensing measurement quality and may determine the availability of favorable fading conditions (e.g., fast or slow fading conditions). In another example, under selective fading conditions, the allocated bandwidth for the sensing measurement is reduced to selectively monitor components causing the signal attenuation. Selectively assessing these components may save power and provide an indication of when these components exhibit different conditions, e.g., indicating that the sensing signal may be sufficient to resume (e.g., default) measurement.

In some embodiments, the alternative sensing measurement configuration configures the WTRU to modify the time window of measurements (e.g., reducing WTRU sampling rate, reducing length of sampling pulse), e.g., to reduce time domain resource allocation. The sampling pulse length may be altered, e.g., if doppler accuracy cannot be achieved, and may be represented as numerical time values (e.g., in ms, seconds, or any other unit of time) or with units with a smaller granularity (e.g., number of symbols, slots, sub-frames, frames). The WTRU may check that the outage still exists in x time slots with a certain periodicity for next 2 seconds.

In some embodiments, the alternative sensing measurement configuration modifies both a time and a bandwidth for performing measurements. In one example, the WTRU detects a micro-doppler outage and activates an alternative sensing measurement configuration that configures the WTRU to reduce bandwidth allocated to sensing reference signal (e.g., to x number of subcarriers) and to take measurements only for 3 OFDM symbols instead of 14 OFDM symbols.

In some embodiments, the alternative sensing measurement configuration configures the WTRU to stop performing measurements (e.g., of metrics in outage or all metrics) and report to the wireless network when the outage occurred and/or which measurements were not performed.

In accordance with certain embodiments of the present disclosure, systems and methods for predicting sensing measurements in outage are described as follows.

In some embodiments, the WTRU processes measurements of one or more metrics (e.g., measurements in outage) and reports the processed measurements to the network. The processing may include predicting (e.g., using a processing function g(·)) missing measurements and/or measurements in outage, e.g., by correcting, filtering, and/or interpolating measurements. The processing may reduce measurement noise and the effects of momentary dips in the measurements, providing more reliable sensing measurements to the network. The processing may additionally increase the accuracy of the measurements and reduce the need for repeating measurements with alternative sensing measurement configurations. The processing may predict the measurement values based on temporal and spatial dependencies of measured signals. In some examples, the WTRU processes (e.g., by correcting, filtering, and/or interpolating) collected measurements even when an outage is not detected. The WTRU may report to the wireless network the processed measurements in place of the original measurements.

In accordance with certain embodiments of the present disclosure, example processing functions (e.g., g(·)) are provided as follows.

In some embodiments, the processing function includes statistical signal processing approaches such as interpolation, smoothing, and Kalman filtering to predict measurement values (e.g., missing measurements, measurements in outage)

In some embodiments, the processing function includes ML approaches such as time series forecasting and DL techniques to predict measurement values (e.g., with higher complexity measurement tasks and outages with longer durations).

In some embodiments, the WTRU employs a separate processing function (e.g., including any combination of the aforementioned approaches) for each sensing metric or may employ a common processing function for multiple sensing metrics.

In some embodiments, the WTRU selects a processing function based on the time and/or duration of a past or present outage. The processing function may also take the time and/or duration of a past or present outage as inputs. In one example, the WTRU does not predict values using a processing function based on determining that the SNR is below a threshold for a long period of time since it may no longer sufficient or necessary to apply processing to the missing measurements and/or measurements in outage (e.g., the accuracy of the predicted values may decrease as the duration of the outage increases).

In some embodiments, the WTRU applies a processing function to fill in gaps of missing sensing measurement data. In one example, the WTRU applies the processing function (e.g., including filtering and/or correction techniques) based on determining that the outage duration is greater than a threshold duration. The threshold duration may be included in the sensing configuration and/or outage information provided to the WTRU by the wireless network.

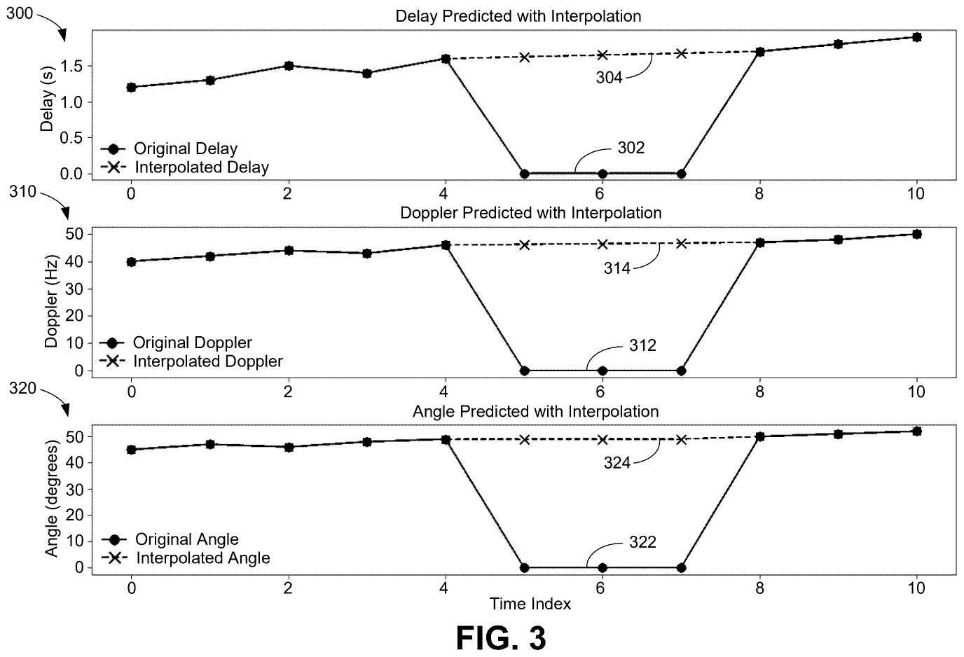

FIG. 3 shows an illustrative approach for predicting sensing metrics (e.g., delay 300, doppler 310, and angle 320) during an outage using interpolation (e.g., linear interpolation).

As shown in FIG. 3, the WTRU (e.g., WTRU 102 of FIGS. 1A-D) may detect an outage of sensing metrics (e.g., at time indices 5, 6, and 7), e.g., based on low SNR caused by brief interference. The WTRU may then interpolate measurements of sensing metrics (e.g., original delay 302, original doppler 312, and original angle 322) to determine predicted measurements (e.g., interpolated delay 304, interpolated doppler 314, and interpolated angle 324) during the outage. In one example, the wireless network requests the WTRU to provide the predicted sensing measurements and the WTRU sends a special report to the wireless network with the predicted sensing measurements (e.g., the interpolated measurements 304, 314, and 324 at time indices 5, 6, and 7). The special report may include an indication of which values were processed by the WTRU (e.g., as opposed to original measurements) and information regarding the processing (e.g., that the sensing measurements were processed using linear interpolation based on low SNR caused by brief interference).

In some embodiments, the wireless network requests the WTRU to process (e.g., by correcting, filtering, or interpolating) sensing measurements during a particular time window. The particular time window may or may not be related to an outage. In one example, the WTRU decides to process measurements that are below a threshold (e.g., below a threshold value, SNR, SINR, and/or RSRP) for a certain time window (e.g., a duration of 100 ms) but does not detect an associated outage. In another example, a WTRU is configured to provide measurements of sensing metrics of a PRS signal every 100 ms. At time t, the WTRU detects an outage and predicts that the outage may have a duration of 200 ms. The WTRU may take sensing measurements at the next PRS signal but may use past values of the one or more sensing metrics, SNR, SINR, and/or RSRP to predict the value of the sensing metrics (e.g., with a processing function) during the outage duration. In another example, the WTRU does not perform measurements during a detected outage (e.g., a predicted future outage) and uses a processing function to predict the values of the sensing measurements during the outage duration and report them to the NW. In this example, the WTRU and/or wireless network is able to save resources and power typically allocated to the measurements that are not performed. The WTRU may include an indication of the time window for which measurements were processed as well as the processing function in the report of processed measurements sent to the wireless network.

The processing function may be provided by the wireless network or may be WTRU vendor specific. In one example, the WTRU uses a processing function that takes as input past sensing measurements along with assistance information regarding a target (e.g., target position) to generate predictions of sensing measurement values. This processing function may include an AI/ML model or any other aforementioned processing approach. In some examples, the wireless network indicates to the WTRU a particular processing function ID or type to apply based on the sensing metric that is in outage.

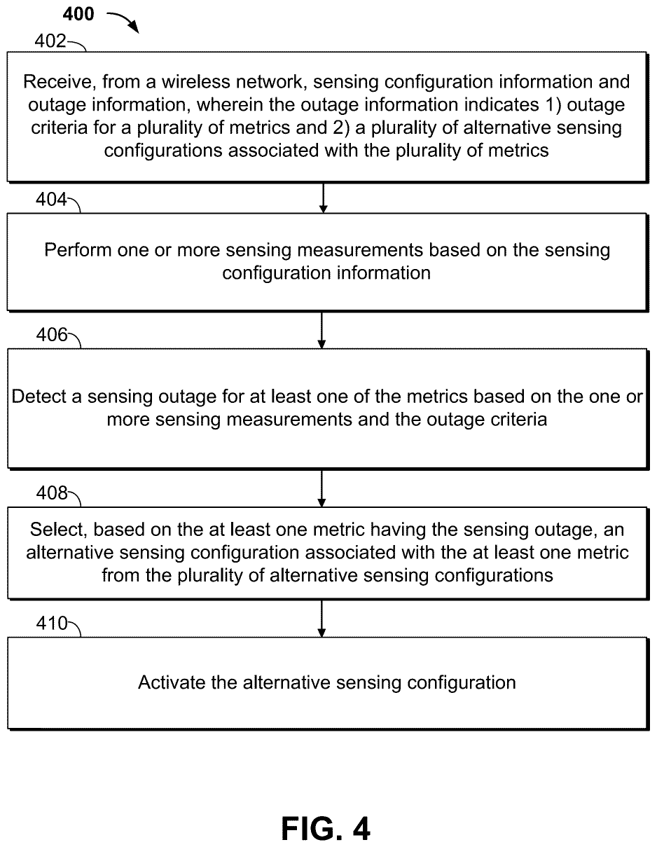

In certain representative embodiments, as shown in FIG. 4, a process 400 is performed by a WTRU (e.g., WTRU 102 of FIGS. 1A-D) in connection with a wireless network (e.g., RAN 104 and 113 of FIGS. 1A-D), which may be implemented in a communication system such as a communications system 100 illustrated in FIG. 1A-1D.

At step 402, the WTRU receives sensing configuration information and outage information from the wireless network. In some embodiments, the WTRU receives outage information that indicates outage criteria for a plurality of metrics and a plurality of alternative sensing configurations associated with the plurality of metrics. For example, the WTRU may receive outage criteria that includes a plurality of thresholds corresponding to a plurality of metrics. In some embodiments, the WTRU receives outage information that indicates total outage criteria (e.g., an indication that a total outage should be detected when outages of two or more metrics are detected).

At step 404, the WTRU performs one or more sensing measurements based on the sensing configuration information. In some embodiments, the WTRU performs the one or more sensing measurements based on sensing measurement configuration information included in the sensing configuration information. For example, the WTRU may perform measurements at a periodicity indicated by the sensing measurement configuration information.

At step 406, the WTRU detects a sensing outage for at least one of the metrics based on the one or more sensing measurements and the outage criteria. In some embodiments, the WTRU detects multiple sensing outages each corresponding to an individual metric. In some embodiments, the WTRU detects a total outage, e.g., corresponding to multiple metrics. In some embodiments, the WTRU detects a sensing outage by predicting a future sensing outage. For example, the WTRU predicts the future sensing outage based on previously detected sensing outages. In some embodiments, the WTRU determines a duration corresponding to the detected sensing outage (e.g., in the past or future). When the WTRU detects a sensing outage for the at least one metric in step 406, the WTRU proceeds to step 408.

At step 408, the WTRU selects, based on the at least one metric having the sensing outage, an alternative sensing configuration associated with the at least one metric from the plurality of alternative sensing configurations. In some embodiments, the WTRU selects an alternative sensing configuration including an alternative sensing measurement configuration. For example, the WTRU may select an alternative sensing configuration that configures the WTRU to perform measurements at a decreased periodicity. In some embodiments, the WTRU selects an alternative sensing configuration including an alternative reporting configuration. For example, the WTRU may select an alternative sensing configuration that configures the WTRU to exclude certain measurements in outage from the sensing report. When the WTRU selects the alternative sensing configuration, the WTRU proceeds to step 410. In some embodiments, the WTRU reports the alternative sensing configuration to the wireless network and waits to receive an acknowledgement from the wireless network before proceeding to step 410.

At step 410, the WTRU activates the alternative sensing configuration. In some embodiments, the WTRU proceeds to perform and/or report one or more additional measurements based on the activated alternative sensing configuration. For example, the WTRU may perform one or more additional measurements based on an activated alternative sensing measurement configuration. Additionally or alternatively, for example, the WTRU may report the one or more additional measurements based on an activated alternative reporting configuration. In some embodiments, when the WTRU has activated the alternative sensing configuration, the WTRU returns to step 404 to perform additional sensing measurements and may proceed to step 406 upon detection of another sensing outage (e.g., based on the additional measurements and the outage criteria). In some embodiments, the WTRU returns to step 402 to receive updated sensing configuration information and outage information from the network.

Certain embodiments of the present disclosure describe a bistatic sensing mode in which a WTRU is a receiver and the network (e.g., gNB) is the transmitter. However, this does not preclude the applicability of the systems and methods described herein to all other sensing modes.

In the present disclosure, “sensing outage” and “outage” are used interchangeably. “Sensing metric”, “metric”, “sensing measurement”, and “measurement” are also used interchangeably herein. Additionally, the term “outage criteria” shall be interpreted herein as comprising the singular form (e.g., a single outage criterion) and the plural form. For example, the “outage criteria” for a metric may be a single criterion such as a SNR being less than a threshold.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network, sensing configuration information and outage information, wherein the outage information indicates 1) outage criteria for a plurality of metrics and 2) a plurality of alternative sensing configurations associated with the plurality of metrics;
performing one or more sensing measurements based on the sensing configuration information;
detecting a sensing outage for at least one of the metrics based on the one or more sensing measurements and the outage criteria;
selecting, based on the at least one metric having the sensing outage, an alternative sensing configuration associated with the at least one metric from the plurality of alternative sensing configurations; and
activating the alternative sensing configuration.

2. The method of claim 1, further comprising:
determining an outage duration based on the one or more sensing measurements and the outage information.

3. The method of claim 1, further comprising:
predicting one or more metric values during the sensing outage; and
reporting the one or more sensing measurements to the wireless network based on the predicted one or more metric values and an indication that the one or more sensing measurements is based on predicted values.

4. The method of claim 3, wherein the predicting the one or more metric values comprises performing an interpolation based on one or more sensing measurements before the sensing outage.

5. The method of claim 1, further comprising:
predicting one of a sensing outage duration or a future sensing outage based on one or more previously detecting sensing outages.

6. The method of claim 1, wherein the alternative sensing configuration is an alternative sensing measurement configuration for performing one or more sensing measurements.

7. The method of claim 6, further comprising:
reporting the alternative sensing measurement configuration to the wireless network; and
receiving an acknowledgement from the wireless network, wherein:
the alternative sensing measurement configuration is activated after receiving the acknowledgement.

8. The method of claim 1, wherein the alternative sensing configuration is an alternative reporting configuration for reporting sensing measurements, and the method further comprises:
reporting the one or more sensing measurements to the wireless network based on the alternative reporting configuration.

9. The method of claim 1, wherein the detecting the sensing outage for at least one of the metrics comprises:
detecting a first sensing outage for a first metric; and
detecting a second sensing outage for a second metric.

10. The method of claim 1, further comprising:
detecting whether there is a sensing outage for each of the plurality of metrics; and
detecting a total sensing outage when the sensing outage is detected for a predetermined number of metrics.

11. A wireless transmit/receive unit (WTRU) comprising:
a processor; and
a transceiver, wherein the WTRU is configured to:
receive, from a wireless network, sensing configuration information and outage information, wherein the outage information indicates 1) outage criteria for a plurality of metrics and 2) a plurality of alternative sensing configurations associated with the plurality of metrics;
perform one or more sensing measurements based on the sensing configuration information;
detect a sensing outage for at least one of the metrics based on the one or more sensing measurements and the outage criteria;
select, based on the at least one metric having the sensing outage, an alternative sensing configuration associated with the at least one metric from the plurality of alternative sensing configurations; and
activate the alternative sensing configuration.

12. The WTRU of claim 11, wherein the WTRU is further configured to:
determine an outage duration based on the one or more sensing measurements and the outage information.

13. The WTRU of claim 11, wherein the WTRU is further configured to:
predict one or more metric values during the sensing outage; and
report the one or more sensing measurements to the wireless network based on the predicted one or more metric values and an indication that the one or more sensing measurements is based on predicted values.

14. The WTRU of claim 13, wherein to predict the one or more metric values comprises performing an interpolation based on one or more sensing measurements before the sensing outage.

15. The WTRU of claim 11, wherein the WTRU is further configured to:
predict one of a sensing outage duration or a future sensing outage based on one or more previously detecting sensing outages.

16. The WTRU of claim 11, wherein the alternative sensing configuration is an alternative sensing measurement configuration for performing one or more sensing measurements.

17. The WTRU of claim 16, wherein the WTRU is further configured to:
report the alternative sensing measurement configuration to the wireless network; and
receive an acknowledgement from the wireless network, wherein:
the alternative sensing measurement configuration is activated after receiving the acknowledgement.

18. The WTRU of claim 11, wherein the alternative sensing configuration is an alternative reporting configuration for reporting sensing measurements, and the WTRU is further configured to:
report the one or more sensing measurements to the wireless network based on the alternative reporting configuration.

19. The WTRU of claim 11, wherein to detect the sensing outage for at least one of the metrics comprises:
detecting a first sensing outage for a first metric; and
detecting a second sensing outage for a second metric.

20. The WTRU of claim 11, wherein the WTRU is further configured to:
detect whether there is a sensing outage for each of the plurality of metrics; and
detect a total sensing outage when the sensing outage is detected for a predetermined number of metrics.
